(19) United States
(12) Patent Application Publication
(10) Pub. No.: US 2023/0025318 A1
(43) Pub. Date: Jan. 26, 2023

(54) CALIBRATION OF AN IMPEDANCE CONTROL OF A ROBOT MANIPULATOR

(71) Applicant: Franka Emika GmbH, München (DE)

(72) Inventors: Andreas Spenninger, Karlsfeld (DE); Marco Morganti, Garching (DE)

(21) Appl. No.: 17/778,097

(22) PCT Filed: Nov. 19, 2020
(86) PCT No.: PCT/EP2020/082659

§ 371 Date: May 19, 2022

(30) Foreign Application Priority Data
Nov. 21, 2019 (DE) 10 2019 131 401.1

(51) Int. Cl. B25J 9/16; B25J 13/08

(52) U.S. Cl. CPC B25J 9/1633; B25J 9/1692; B25J 13/088

(57) ABSTRACT

A method of calibrating an impedance control of a robot manipulator, the method including: deflecting a reference point of the robot manipulator from a zero position to a deflected position, wherein the robot manipulator applies a counterforce dependent on a spring constant of the impedance control and on a first determined deflection, wherein the first determined deflection is determined based on joint angles detected by joint angle sensors of the robot manipulator; detecting a second determined deflection by an external position measuring unit; and adapting the spring constant of the impedance control in such a way that the counterforce applied by the robot manipulator corresponds to a predetermined counterforce of the robot manipulator based on the second determined deflection.

### CROSS-REFERENCE TO RELATED APPLICATIONS

The present application is the U.S. National Phase of PCT/EP2020/082659, filed on 19 Nov. 2020, which claims priority to German Patent Application No. 10 2019 131 401.1, filed on 21 Nov. 2019, the entire contents of which are incorporated herein by reference.

### BACKGROUND

### Field

The invention relates to a method for calibrating an impedance control of a robot manipulator and a robot system having a robot arm and having a control unit for carrying out the calibrated impedance control.

### SUMMARY

The object of the invention is to improve the impedance control of a robot manipulator or a robot system.

The invention results from the features of the independent claims. Advantageous refinements and embodiments are the subject matter of the dependent claims.

A first aspect of the invention relates to a method of calibrating an impedance control of a robot manipulator, wherein the robot manipulator includes a plurality of links connected to one another by joints, the method including:
deflecting a reference point of the robot manipulator from a zero position to a deflected position, wherein the robot manipulator applies a counterforce dependent on a spring constant of the impedance control and on a first determined deflection of the reference point of the robot manipulator, wherein the first determined deflection is determined based on joint angles detected by joint angle sensors of the robot manipulator;
detecting a second determined deflection of the reference point of the robot manipulator in its deflected position by an external position measuring unit; and
adapting the spring constant of the impedance control in such a way that the counterforce applied by the robot manipulator corresponds to a predetermined counterforce of the robot manipulator based on the second determined deflection.

Whether the counterforce of the robot manipulator based on the second determined deflection is actually applied in the last step of the method is irrelevant here, since the calibration of the impedance control is completed with the adaptation of the spring constant of the impedance control.

The impedance control preferably takes the following form:

u=−J^{T}(θ)(Kₓ\tilde{x}(θ)+Dₓ\dot{x}(ω))+g(θ), wherein the following applies: \tilde{x}(θ)=f(θ)−xₛ

wherein:
θ: are the joint angles of the robot manipulator;
u: is the counterforce of the robot manipulator;
J^{T}(θ): is the transposed Jacobian matrix, depending on the current joint angles;
Kₓ: is the spring constant;
Dₓ: is the damping constant;
g(θ): is a gravity compensation of the impedance control;
\tilde{x}: is the deflection of the reference point of the robot manipulator;
\dot{x}: is the speed of the reference point of the robot manipulator;
xₛ: is the zero position of the reference point of the robot manipulator; and
f(θ): is the deflected position of the reference point of the robot manipulator.

In particular, when there is no speed of the reference point or no damping constant is provided, and neglecting the force of gravity, the adapted spring constant can be determined from the term u=−J^{T}(θ)Kₓ\tilde{x} by appropriate transformation based on the second determined deflection.

The reference point of the robot manipulator is, in particular, any reference point of the robot manipulator that can be selected by a user, i.e., the reference point is arranged, imagined physically fixed on a limb or a joint or on another component of the robot manipulator, or at least moves in a physically fixed manner with the limb or the joint or the component of the robot manipulator.

The external position measuring unit differs from the joint angle sensors in particular in that it is not arranged on the robot manipulator itself and does not use the robot's own sensors. Instead, a motion capture system (so-called “motion capture system”) is preferably used as the position measuring unit, in which cameras detect light reflected from the robot manipulator or from special markers on the robot manipulator and, through their corresponding calibration, can detect the position of the reference point of the robot manipulator in the earth-fixed space quite precisely. Alternatively, another position measuring unit is preferably used, wherein a plurality of possible known position measuring units come into consideration, for example, electronic measuring sensors, ultrasonic distance measuring units, a radar unit, stereo cameras, etc.

The joint angle sensors of the robot manipulator, on the other hand, are in particular, the robot's own sensors, which detect a respective angle between two links of the robot manipulator that are connected to one another by a common joint. From the totality of all joint angles, a position of the reference point of the robot manipulator can be inferred, in particular with respect to an earth-fixed system, by corresponding coordinate system transformations or vector algebra or alternative mathematical methods. This naturally results in certain inaccuracies, since one or more of the joint angle sensors can have inaccuracies or errors, which can increase, in particular, in certain poses of the robot manipulator and due to the nature of the coordinate system transformations.

The spring constant of the impedance control can be a scalar spring constant or a spring constant in matrix form, which is particularly suitable for deflecting the reference point of the robot manipulator in different directions with directional dependence of the spring constant. In the latter case, the spring constant is preferably a diagonal matrix, but components outside the diagonal of a matrix-shaped spring constant are also possible, in particular, if couplings between the designed directions of the reference point of the robot manipulator are desired. The zero position of the reference point of the robot manipulator is that position, in particular, with respect to a Cartesian, earth-fixed coordinate system, in which the robot manipulator does not generate counterforce. This corresponds to the rest position of a real mechanical spring, in which the mechanical spring does not generate any force.

According to the invention, the deflection of the reference point of the robot manipulator is carried out simultaneously in two ways: on the one hand via the robot's own joint angle sensors, on the other hand via the external position measuring unit. Under the assumption that the measurements of the external position measuring unit are correct and only the joint angle sensors or at least one of them is faulty, the second determined deflection of the reference point of the robot manipulator can also be used to determine a counterforce, which the impedance control would have to apply based on this second determined deflection. This counterforce will deviate somewhat from the counterforce actually applied, since the joint angle sensors naturally output joint angles due to sensor noise, coordinate system transformation, and other effects, which result in a slightly different position of the reference point in an earth-fixed, Cartesian coordinate system than the determined position of the reference point of the robot manipulator, which is output from the external position measuring unit. Therefore, according to the invention, the spring constant of the impedance control is adapted in such a way that the counterforce applied by the robot manipulator against the deflection is or would be as large as if the impedance control had been calculated with the original spring constant using the second determined position of the reference point of the robot manipulator. According to the invention, the spring constant thus compensates for the measurement error of the joint angle sensors based on the position detection of the external position measuring unit.

It is an advantageous effect of the invention that the impedance control is adapted according to the inaccuracies and errors in the measurement of joint angles by joint angle sensors of the robot manipulator, and thus these inaccuracies and errors in the operation of a robot arm or robot manipulator are compensated for using the calibrated impedance control.

According to an advantageous embodiment, after the deflection of the reference point of the robot manipulator from the zero position to the deflected position, the reference point of the robot manipulator is held in the deflected position and the second determined deflection is detected while the reference point of the robot manipulator is being held in the deflected position, wherein the adaptation of the spring constant of the impedance control takes place in such a way that the counterforce applied by the robot manipulator corresponds to a stationary counterforce of the robot manipulator based on the second deflection. In particular, if the impedance control not only contains an artificial spring in the form of a spring constant, but also a damping constant that generates a speed-dependent counterforce against the movement of the reference point of the robot manipulator, this embodiment ensures that only the spring constant is adjusted depending on the second determined deflection, and speed influences due to the effect of the damping constant have no effect on the adaptation of the spring constant of the impedance control.

According to a further advantageous embodiment, the method further includes:
determining a speed of the reference point of the robot manipulator at at least one location of the deflection by an external speed measuring unit; and
adapting the damping constant of the impedance control in such a way that the counterforce applied by the robot manipulator corresponds to a predetermined counterforce of the robot manipulator based on the second determined deflection and based on the determined speed.

In contrast to the preceding embodiment, speeds of the reference point of the robot manipulator are explicitly taken into consideration in this embodiment. At least one speed is advantageously determined or detected at one location during the deflection of the reference point from its zero position to its deflected position and taken into consideration in addition to the current deflection. The speed measuring unit can be part of the position measuring unit and can be determined from the time derivative of measured positions.

According to a further advantageous embodiment, the spring constant is constant over the deflection of the reference point between its zero position and its deflected position. According to this embodiment, the spring constant is invariant over time, that is to say it does not change, in particular, over the deflection of the reference point of the robot manipulator. This creates a linear artificial spring for the reference point of the robot manipulator.

According to a further advantageous embodiment, the spring constant is dependent on the current deflection of the reference point of the robot manipulator. In contrast to the preceding embodiment, the impedance control has a non-linear spring law here due to the deflection-dependent spring constant. This is usable advantageously, in particular, when a nonlinear impedance control is desired for specific applications. The method according to the first aspect of the invention or the associated embodiments is advantageously repeated for multiple positions of the reference point of the robot manipulator as the zero position in space in order to obtain multiple support points for the adaptation of the spring constant, and thus to take into consideration the non-linearity of the artificial spring in the impedance control.

According to a further advantageous embodiment, the spring constant of the impedance control is adapted in modal coordinates. The modal coordinate transformation transforms the differential equation of the impedance control depending on, among other things, an inertia matrix of the impedance control, so that a coupled dynamic of the impedance control over different directions of deflection is decoupled by appropriate transformation and is provided in modal coordinates. This advantageously simplifies the design, in particular, of the spring constant, since the respective component of the spring constant can be adapted in decoupled coordinates. This method can also be applied to the design of a damping constant, if one is provided in the impedance control.

According to a further advantageous embodiment, the reference point of the robot manipulator is deflected from the zero position into the deflected position by manual guiding of the robot manipulator by a user.

According to a further advantageous embodiment, the reference point of the robot manipulator is deflected from the zero position into the deflected position by corresponding activation of actuators of the robot manipulator.

According to a further advantageous embodiment of the robot manipulator, the method includes repeating the deflecting the reference point, detecting the second determined deflection, and adapting the spring constant of the impedance control for a plurality of different deflection ranges and/or in different deflection directions of the reference point of the robot manipulator, wherein the spring constant is adapted in dependence on a respective deflection range and/or a respective deflection direction. In particular, this embodiment takes into consideration the fact that typically the errors and inaccuracies in the joint angle sensors of the robot manipulator are deflection-dependent and direction-dependent. A data series for different stiffness matrices over different deflection widths or different deflection directions is thus created and the errors and inaccuracies of the joint angle sensors of the robot manipulator are compensated for in an improved manner.

A further aspect of the invention relates to a robot system having a robot arm and having a control unit, wherein the control unit is designed to carry out an impedance control of the robot arm, wherein the impedance control is calibrated according to a method.

The robot system having the robot arm and having the control unit can coincide here with the robot manipulator according to the first aspect of the invention and its embodiments. This means that the adapted spring constant and/or the adapted damping matrix can also be used on the same robot manipulator on which the method for calibrating the impedance control is carried out. Alternatively, the method for calibrating the impedance control is preferably carried out on a first robot manipulator, and such a calibrated impedance control is used on a second or a plurality of second robot manipulators (i.e., the respective robot system having the robot arm and the respective control unit). The result of the calibration is thus also advantageously transferable from a robot manipulator to a robot system having a robot arm and a control unit.

Further advantages, features, and details will be apparent from the following description, in which—possibly with reference to the drawings—at least one example embodiment is described in detail. Identical, similar, and/or functionally identical parts are provided with identical reference numerals.

### BRIEF DESCRIPTION OF THE DRAWINGS

In the drawings:

FIG. 1 shows a method according to an example embodiment of the invention;

FIG. 2 shows a robot manipulator on which the method according to FIG. 1 is carried out; and

FIG. 3 shows a robot system having a robot arm according to a further example embodiment of the invention.

The illustrations in the figures are schematic and not to scale.

### DETAILED DESCRIPTION

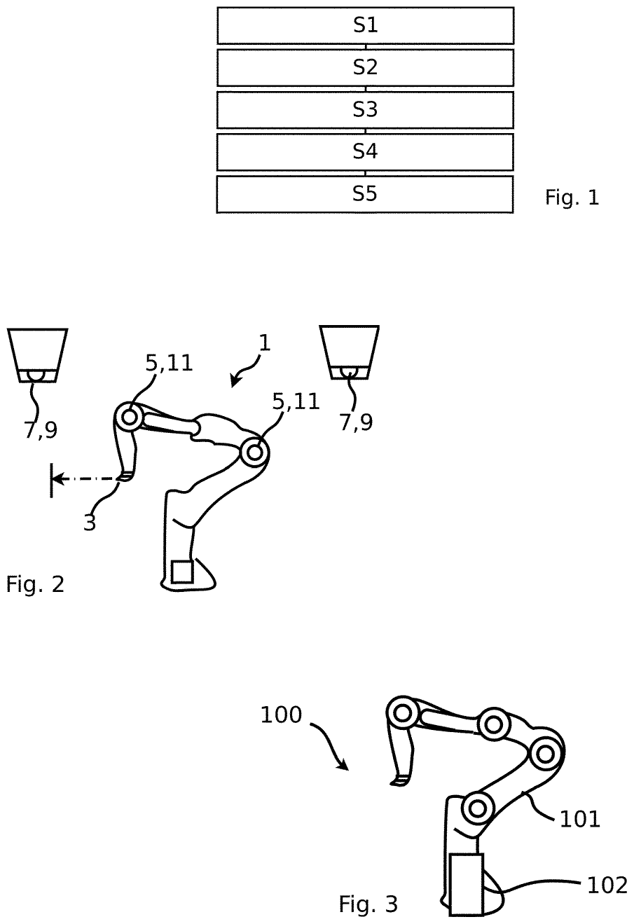

FIG. 1 shows a method for calibrating an impedance control of a robot manipulator 1, wherein the robot manipulator 1 has a plurality of links connected to one another by joints. In a step S1, a reference point 3 on an end effector of the robot manipulator 1 is deflected from a zero position into a deflected position. The robot manipulator 1 is guided manually, and the actuators 11 generate a counterforce against the deflection. Naturally, the reference point 3 remains at least briefly in a rest position before the robot manipulator 1 is released, without having a speed. In this rest position, the respective deflection is detected. The counterforce of the robot manipulator 1 is generated by an impedance control, which has a spring constant in the form of a diagonal matrix, and by the level of a first determined deflection of the reference point 3 of the robot manipulator. The first determined deflection is determined based on joint angles detected by joint angle sensors 5 of the robot manipulator 1. In step S2, the same deflection is additionally detected as the second determined deflection of the reference point 3 of the robot manipulator 1 in its deflected position. This is carried out using an external position measuring unit 7, which includes multiple cameras. Finally, in step S3, this is followed by adapting the spring constant of the impedance control in such a way that the counterforce applied by the robot manipulator 1 corresponds to a predetermined counterforce of the robot manipulator 1 based on the second determined deflection. The adapted spring constant is assigned to the position of the reference point 3 of the robot manipulator 1 in its zero position and stored with the assignment. Steps S1-S3 are repeated for various positions of the reference point 3 of the robot manipulator 1 in its zero position in each case, resulting in a three-dimensional grid of positions for the reference point 3 of the robot manipulator 1 in its respective zero position, wherein a separately adapted spring constant is available for each of the grid points. When the robot manipulator 1 is released, it moves back into its zero position in a damped movement due to the counterforce of the actuators 11. For the adaptation of the damping constant similarly to the spring constant, which is selected to achieve an aperiodic limiting case of the homogeneous solution of the impedance control formulated as a differential equation, a speed of the reference point 3 of the robot manipulator 1 is determined in step S4 at a location of the still deflected reference point 3 while it swings back into the zero position by the external speed measuring unit 9, which corresponds to the position measuring unit 7 and generates the time derivative of the measured position curve over time of the reference point 3 of the robot manipulator 1. This is followed by step S5 of adapting the damping constant of the impedance control in such a way that the counterforce applied by the robot manipulator 1 corresponds to a predetermined counterforce of the robot manipulator 1 based on the second determined deflection at the location while it swings back and based on the speed determined at this location.

FIG. 2 shows a robot manipulator 1 on which the method according to FIG. 1 is carried out. The steps of the method will therefore not be repeated, instead reference is made to the description of FIG. 1. The components and units shown are also explained therein.

FIG. 3 shows a robot system 100 having a robot arm 101 and having a control unit 102, wherein the control unit 102 is designed to carry out an impedance control of the robot arm 101, wherein the impedance control is calibrated according to the method according to FIG. 1 for the robot manipulator 1 according to FIG. 2. The user of the robot system 100 can optionally read in and use the data series of the calibrated spring constant assigned to the three-dimensional grid of positions for the reference point 3 and the calibrated damping constant on the control unit 102 of the robot arm 101. This is possible for a plurality of robot systems 100 having a respective robot arm 101 and having a respective control unit 102, but is shown as an example for only a single robot system 100 in FIG. 3.

Although the invention has been further illustrated and described in detail by way of preferred example embodiments, the invention is not limited by the disclosed examples, and other variations can be derived therefrom by a person skilled in the art without departing from the scope of protection of the invention. It is therefore clear that a plurality of possible variations exists. It is also clear that embodiments mentioned by way of example actually only represent examples, which are not to be construed in any way as limiting the scope of protection, the possible applications, or the configuration of the invention. Rather, the preceding description and the description of the figures enable a person skilled in the art to implement the example embodiments, wherein a person skilled in the art, knowing the disclosed concept of the invention, can make various changes, for example, with respect to the function or arrangement of individual elements cited in an example embodiment, without leaving the scope of protection as defined by the claims and their legal equivalents, such as more extensive explanations in the description.

### LIST OF REFERENCE NUMERALS

1 robot manipulator
3 reference point
5 joint angle sensors
7 external position measuring unit
9 external speed measuring unit
11 actuators
100 robot system
101 robot arm
102 control unit
S1 deflect
S2 detect
S3 adapt
S4 determine
S5 adapt

1. A method of calibrating an impedance control of a robot manipulator, wherein the robot manipulator comprises a plurality of links connected to one another by joints, the method comprising:
deflecting a reference point of the robot manipulator from a zero position to a deflected position, wherein the robot manipulator applies a counterforce dependent on a spring constant of the impedance control and on a first determined deflection of the reference point of the robot manipulator, wherein the first determined deflection is determined based on joint angles detected by means of joint angle sensors of the robot manipulator;
detecting a second determined deflection of the reference point of the robot manipulator in its deflected position by an external position measuring unit; and
adapting the spring constant of the impedance control in such a way that the counterforce applied by the robot manipulator corresponds to a predetermined counterforce of the robot manipulator based on the second determined deflection.

2. The method according to claim 1, wherein after deflection of the reference point of the robot manipulator from the zero position to the deflected position, the method comprises:
holding the reference point of the robot manipulator in the deflected position;
detecting the second determined deflection while the reference point of the robot manipulator is being held in the deflected position; and
adapting the spring constant of the impedance control in such a way that the counterforce applied by the robot manipulator corresponds to a stationary counterforce of the robot manipulator based on the second determined deflection.

3. The method according to claim 1, wherein the method further comprises:
determining a speed of the reference point of the robot manipulator at at least one location of deflection of the reference point by an external speed measuring unit, and
adapting a damping constant of the impedance control in such a way that the counterforce applied by the robot manipulator corresponds to the predetermined counterforce of the robot manipulator based on the second determined deflection and based on the speed of the reference point as determined.

4. The method according to claim 1, wherein the spring constant is constant over the deflection of the reference point between its zero position and its deflected position.

5. The method according to claim 1, wherein the spring constant is dependent on a current deflection of the reference point of the robot manipulator.

6. The method according to claim 1, wherein adaptation of the spring constant of the impedance control takes place in modal coordinates.

7. The method according to claim 1, wherein the reference point of the robot manipulator is deflected from the zero position to the deflected position by manual guiding of the robot manipulator by a user.

8. The method according to claim 1, wherein the reference point of the robot manipulator is deflected from the zero position to the deflected position by corresponding activation of actuators of the robot manipulator.

9. The method according to claim 1, wherein the method comprises repeating the deflecting the reference point of the robot manipulator, detecting the second determined deflection, and adapting the spring constant of the impedance control for a plurality of different deflection ranges and/or in different deflection directions of the reference point of the robot manipulator, wherein the spring constant is adapted in dependence on a respective deflection range and/or a respective deflection direction.

10. A robot system comprising:
a robot manipulator; and
a control unit configured to carry out an impedance control of the robot manipulator, wherein the impedance control is calibrated by the control unit configured;
deflect a reference point of the robot manipulator from a zero position to a deflected position, wherein the robot manipulator applies a counterforce dependent on a spring constant of the impedance control and on a first determined deflection of the reference point of the robot manipulator, wherein the first determined deflection is determined based on joint angles detected by joint angle sensors of the robot manipulator;
detect a second determined deflection of the reference point of the robot manipulator in its deflected position by an external position measuring unit, and
adapt the spring constant of the impedance control in such a way that the counterforce applied by the robot manipulator corresponds to a predetermined counterforce of the robot manipulator based on the second determined deflection.

11. The robot system according to claim 10, wherein after deflection of the reference point of the robot manipulator from the zero position to the deflected position, the control unit is configured to:
hold the reference point of the robot manipulator in the deflected position;
detect the second determined deflection while the reference point of the robot manipulator is being held in the deflected position; and
adapt the spring constant of the impedance control in such a way that the counterforce applied by the robot manipulator corresponds to a stationary counterforce of the robot manipulator based on the second determined deflection.

12. The robot system according to claim 10, wherein the control unit is configured to:
determine a speed of the reference point of the robot manipulator at at least one location of deflection of the reference point by an external speed measuring unit, and
adapt a damping constant of the impedance control in such a way that the counterforce applied by the robot manipulator corresponds to the predetermined counterforce of the robot manipulator based on the second determined deflection and based on the speed of the reference point as determined.

13. The robot system according to claim 10, wherein the spring constant is constant over deflection of the reference point between its zero position and its deflected position.

14. The robot system according to claim 10, wherein the spring constant is dependent on a current deflection of the reference point of the robot manipulator.

15. The robot system according to claim 10, wherein adaptation of the spring constant of the impedance control takes place in modal coordinates.

16. The robot system according to claim 1, wherein the reference point of the robot manipulator is deflected from the zero position to the deflected position by manual guiding of the robot manipulator by a user.

17. The robot system according to claim 10, wherein the reference point of the robot manipulator is deflected from the zero position to the deflected position by corresponding activation of actuators of the robot manipulator.

18. The robot system according to claim 10, wherein the control unit is configured to repeat deflection of the reference point of the robot manipulator, detection of the second determined deflection, and adaptation of the spring constant of the impedance control for a plurality of different deflection ranges and/or in different deflection directions of the reference point of the robot manipulator, wherein the spring constant is adapted in dependence on a respective deflection range and/or a respective deflection direction.
